(19) United States
(12) Patent Application Publication
(10) Pub. No.: US 2007/0192395 A1
(43) Pub. Date: Aug. 16, 2007

(54) METHOD FOR DATABASE-DRIVEN ESTIMATE OF AN OUTPUT QUANTITY IN A K-DIMENSIONAL VALUE RANGE

(75) Inventor: Christian ZECHA, Groebenzell (DE)

Correspondence Address: GREENBLUM & BERNSTEIN, P.L.C., 1950 ROLAND CLARKE PLACE, RESTON, VA, 20191, US

(73) Assignee: EADS DEUTSCHLAND GMBH, Ottobrunn (DE)

(21) Appl. No.: 11/674,841

(22) Filed: Feb. 14, 2007

(30) Foreign Application Priority Data
Feb. 15, 2006 (DE) 10 2006 007 006.2

(51) Int. Cl. G06F 7/38

(52) U.S. Cl. 708/490

(57) ABSTRACT

Method for the database-driven estimate of an output quantity in a k-dimensional value range. The method includes determining a location probability range Rᵢ for a k-dimensional output quantity for an element i of a measurement series {i=1, . . . ,n}, in which the location probability range Rᵢ is limited by a lower (k−1) dimensional area and an upper (k−1) dimensional area, both of which are predetermined or parameterized with sensor measured values or derived from a database taking into account additional sensor measured values, and quantizing the lower limiting area and the upper limiting area by assigning a lower limiting value and an upper limiting value of the i^{th} location probability range Rᵢ to each point in a predetermined (k−1) dimensional search grid. The index i=1, . . . ,n refers to the respective location probability range Rᵢ and the index v refers to the points in the search grid. The method also includes assigning a number to each limiting value, in which the number corresponds to how many location probability ranges Rᵢ the point lies, and the number respectively states in how many location probability ranges Rᵢ the point lies, such that the special case n=1 applies to all the grid points. The method further includes determining a probability range S for the output quantity to be estimated, in which at least m of the n location probability ranges Rᵢ overlap, such that, when the number assigned to the limiting value is larger than or equal to m, each point lies within the probability range S.

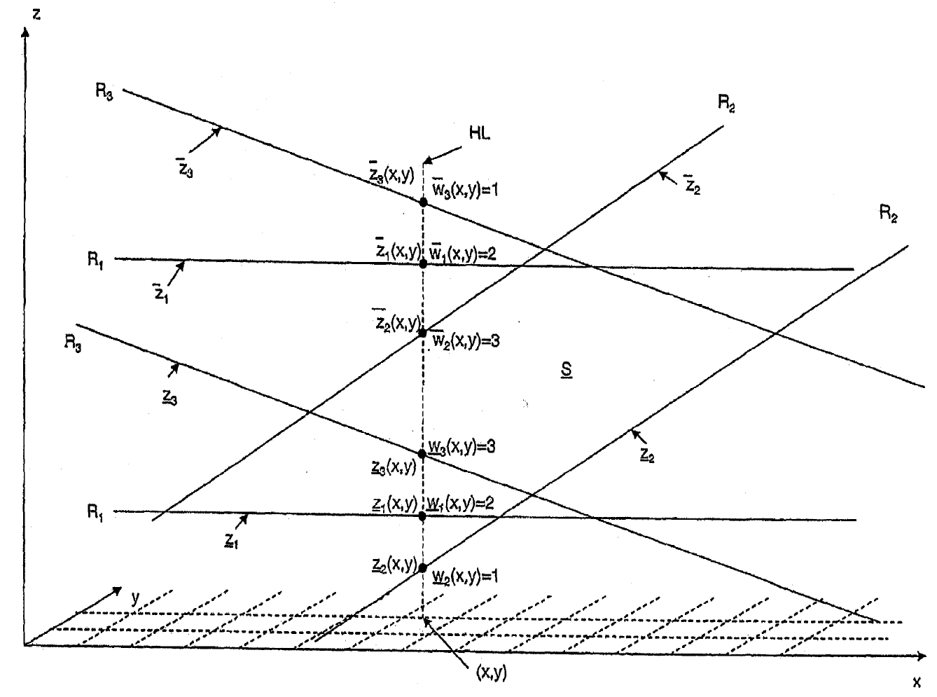

### CROSS-REFERENCE TO RELATED APPLICATIONS

The present application claims priority under 35 U.S.C. §119 of German Patent Application No. DE 10 2006 007 006.2, filed on Feb. 15, 2006, the disclosure of which is expressly incorporated by reference herein in its entirety.

### BACKGROUND OF THE INVENTION

1. Field of the Invention

The invention relates to a method for the database-driven estimate of an output quantity (\vec{x}, z) in a k-dimensional value range.

2. Discussion of Background Information

As is known, Terrain Referenced Navigation is a navigation method in which the current position of the aircraft is determined by a section of the terrain profile of the respective region flown over, the air route, using a digital terrain model, and is made available for navigation. The altitude of the aircraft above the terrain is hereby determined by a sensor.

First, before these data can be provided for the actual position determination algorithm, a section of the terrain profile with a minimum length is preprocessed. The position determination algorithm uses the transferred section of terrain profile and compares it to the stored terrain data of its digital terrain model. Starting from an assumed position, the profile is hereby shifted in a matrix evenly in several steps in the east and west direction as well as in the north and south direction. (http://de.wikipedia.org/wiki/Terrain_Referenced_Navigation).

The most probable horizontal and vertical position of the aircraft is then determined in the form of a spatial overlap range, in which a predetermined number m of location probability ranges of the aircraft overlap. The most probable position of the aircraft is linked in particular to the altitude of the aircraft above the terrain.

For the determination of this type of 3-dimensional overlap range of a plurality of location probability ranges of the aircraft shaped in a complex manner, a 3-dimensional grid is laid over the entire space. The number of location probability ranges in which each grid point is contained is then counted up.

This approach, which essentially means searching a discrete 3-dimensional grid, is on the one hand very time-consuming, as the number of grid points to be searched is generally very high. On the other hand, the fineness of the grid determines the accuracy with which the overlap range can be resolved. A finer grid hereby permits higher accuracy, but at the expense of the time required.

### SUMMARY OF THE INVENTION

The present invention provides a method for the database-driven estimate of an output quantity in a k-dimensional value range.

According to the invention, the method for the database-driven estimate of an output quantity (\vec{x}, z) in a k-dimensional value range includes determining a location probability range Rᵢ for the k-dimensional output quantity (\vec{x}, z) for an element i of a measurement series {i=1, . . . ,n}. In this regard, the location probability range Rᵢ is limited by a lower (k−1) dimensional area z₁ that is predetermined or parameterized with sensor measured values or derived from a database taking into account additional sensor measured values, and by an upper (k−1) dimensional area z̅ᵢ that is predetermined or parameterized with sensor measured values or derived from a database taking into account additional sensor measured values. The method further includes quantizing the lower and upper limiting areas zᵢ, z̅ᵢ by assigning a lower limiting value zᵢ (\vec{x}ᵥ) and an upper limiting value z̅ᵢ (\vec{x}ᵥ) of the i^{th} location probability range Rᵢ to each point \vec{x}ᵥ in a predetermined (k−1) dimensional search grid. The index i=1, . . . ,n refers to the respective location probability range Rᵢ and the index v refers to the points in the search grid. The method includes assigning a number wᵢ(\vec{x}ᵥ) or w̅ᵢ(\vec{x}ᵥ) to each limiting value zᵢ(\vec{x}ᵥ) or z̅ᵢ(\vec{x}ᵥ), such that the number wᵢ(\vec{x}ᵥ) respectively states in how many location probability ranges R_{I} the point (\vec{x}ᵥ, zᵢ, (\vec{x}ᵥ)) lies, and the number w̅ᵢ(\vec{x}ᵥ) respectively states in how many location probability ranges R_{I} the point (\vec{x}ᵥ, z̅ᵢ(\vec{x}ᵥ)) lies. In this manner, in a special case n=1, w₁(\vec{x}ᵥ)=1 and w̅₁(\vec{x}ᵥ)=1 applies to all the grid points \vec{x}ᵥ. The method also includes determining a probability range S for the output quantity (\vec{x}, z) to be estimated, in which range S at least m of the n location probability ranges Rᵢ overlap. In this regard, each point (\vec{x}ᵥ, z̅ᵢ(\vec{x}ᵥ)) or (\vec{x}ᵥ, z̅ᵢ(\vec{x}ᵥ)) lies within the probability range S if the number wᵢ(\vec{x}ᵥ) or w̅ᵢ(\vec{x}ᵥ) assigned to the limiting value zᵢ(\vec{x}ᵥ) or z̅ᵢ(\vec{x}ᵥ) is larger than or equal to m, such that the entire connecting distance of two points (\vec{x}ᵥ,zᵢ(\vec{x}ᵥ)), (\vec{x}ᵥ, z̅ⱼ(\vec{x}ᵥ)) lies within the probability range S if zᵢ(\vec{x}ᵥ)≦ z̅ⱼ(\vec{x}ᵥ), wᵢ(\vec{x}ᵥ)≧m, and w̅ⱼ(\vec{x}ᵥ)≧m applies and no limiting value z₁(\vec{x}ᵥ) or z̅₁(\vec{x}ᵥ) with w₁(\vec{x}ᵥ)≦m or w̅₁(\vec{x}ᵥ)≦m exists between zᵢ(\vec{x}ᵥ), z̅ⱼ(\vec{x}ᵥ).

If the method is discontinued at a predefined number n of location probability ranges, the number of the overlapping location probability ranges for each point \vec{x}xᵥ of the (k−1) dimensional search grid can be read directly from the numbers w̅ᵢ(\vec{x}ᵥ) and wᵢ(\vec{x}ᵥ).

In the method according to the invention, first a dimension of the k-dimensional search space is separated off. This is associated with a considerable reduction in computing time.

A (k−1) dimensional search grid {\vec{x}ᵥ} is accordingly laid over the resulting (k−1) dimensional search space. A (k−1) dimensional search grid of this type is generally required as long as the individual location probability ranges Rᵢ can assume arbitrarily complex shapes, i.e., as long as the limiting areas zᵢ and z̅ᵢ can be shaped arbitrarily.

For the specific 3-dimensional case this means that one space dimension, expediently the dimension of the direct measured quantity, is separated off. In the example of determining the position of an aircraft, this is the altitude or the z-dimension in a Cartesian coordinate system. A 2-dimensional search grid is subsequently laid over the x-y plane. For each point (x, y) of the 2-dimensional search grid that z-interval is then determined exactly in which at least m space ranges overlap. A quantization in the z-dimension is not required for this.

If, in the specific case, the 3-dimensional space comprises, e.g., 1000 grid points per dimension, the method according to the invention reduces the computing time by a factor of up to 1000, as the 1000 grid points in the z-direction do not have to be searched.

The present invention is directed to a method for the database-driven estimate of an output quantity (\vec{x}, z) in a k-dimensional value range. The method includes determining a location probability range Rᵢ for a k-dimensional output quantity (\vec{x}, z) for an element i of a measurement series {i=1, . . . ,n}, in which the location probability range Rᵢ is limited by a lower (k−1) dimensional area zᵢ and an upper (k−1) dimensional area z̅ᵢ, both of which are predetermined or parameterized with sensor measured values or derived from a database taking into account additional sensor measured values, and quantizing the lower limiting area zᵢ and the upper limiting area z̅ᵢ by assigning a lower limiting value zᵢ(\vec{x}ᵥ) and an upper limiting value z̅ᵢ(\vec{x}ᵥ) of the i^{th} location probability range Rᵢ to each point \vec{x}ᵥ in a predetermined (k−1) dimensional search grid. The index i=1, . . . ,n refers to the respective location probability range Rᵢ and the index v refers to the points in the search grid. The method also includes assigning a number wᵢ(\vec{x}ᵥ) or w̅ᵢ(\vec{x}ᵥ) to each limiting value zᵢ(\vec{x}ᵥ) or z̅ᵢ(\vec{x}ᵥ), in which the number wᵢ(\vec{x}ᵥ) corresponds to how many location probability ranges Rᵢ the point (\vec{x}ᵥ, zᵢ(\vec{x}ᵥ)) lies, and the number w̅ᵢ(\vec{x}ᵥ) respectively states in how many location probability ranges Rᵢ the point (\vec{x}ᵥ, z̅ᵢ(\vec{x}ᵥ)) lies, such that the special case n=1, w₁(\vec{x}ᵥ)=1 and w̅₁(\vec{x}ᵥ)=1 applies to all the grid points \vec{x}ᵥ. The method further includes determining a probability range S for the output quantity to be estimated (\vec{x}, z), in which at least m of the n location probability ranges Rᵢ overlap, such that, when the number wᵢ(x) or w̅ᵢ(\vec{x}ᵥ) assigned to the limiting value zᵢ(\vec{x}ᵥ) or z̅ᵢ(\vec{x}ᵥ) is larger than or equal to m, each point (\vec{x}ᵥ,zᵢ(\vec{x}ᵥ)) or (\vec{x}ᵥ, z̅ᵢ(\vec{x}ᵥ)) lies within the probability range S, and, such that, when zᵢ(\vec{x}ᵥ)≦ z̅ⱼ(\vec{x}ᵥ), wᵢ(\vec{x}ᵥ)≧m w̅ⱼ(\vec{x}ᵥ)≧m applies and no limiting value zₗ(\vec{x}ᵥ) or z̅ₗ(\vec{x}ᵥ) with wᵢ(\vec{x}ᵥ)≦m or w̅ₗ(\vec{x}ᵥ)≦m exists between zᵢ(\vec{x}ᵥ), z̅ⱼ(\vec{x}ᵥ), the entire connecting distance of two points (\vec{x}ᵥ,zᵢ(\vec{x}ᵥ)), (\vec{x}ᵥ, z̅ⱼ(\vec{x}ᵥ)) lies within the probability range S.

According to a feature of the invention, the method may further include adding another location probability range Rₙ₊₁ to the already existing location probability ranges Rᵢ, i=1, . . . ,n, and, for each grid point \vec{x}ᵥ, quantizing lower limiting area zₙ₊₁ and upper limiting area z̅ₙ₊₁ of the (n+1)^{th} location probability range Rₙ₊₁ by assigning a lower limiting value zₙ₊₁(\vec{x}ᵥ) and an upper limiting value z̅ₙ₊₁(\vec{x}ᵥ) to the grid point \vec{x}ᵥ, assigning a number wₙ₊₁(\vec{x}ᵥ) or w̅ₙ₊₁(\vec{x}ᵥ) to each limiting value zₙ₊₁(\vec{x}ᵥ) or z̅ₙ₊₁(\vec{x}ᵥ), respectively provided with the initialization value wₙ₊₁(\vec{x}ᵥ)=1 or w̅ₙ₊₁(\vec{x}ᵥ)=1, incrementing from wₙ₊₁(\vec{x}ᵥ) by 1, for each i=1, . . . , n for which the relation zᵢ(\vec{x}ᵥ)<zₙ₊₁(\vec{x}ᵥ) is fulfilled, otherwise incrementing from wᵢ(\vec{x}ᵥ) by 1, decrementing from wₙ₊₁(\vec{x}ᵥ) by 1, for each i=1, . . . , n for which the relation z̅ᵢ(\vec{x}ᵥ)<zₙ₊₁(\vec{x}ᵥ) is fulfilled, otherwise incrementing from w̅ᵢ(\vec{x}ᵥ) by 1, incrementing from w̅ₙ₊₁(\vec{x}ᵥ) by 1, for each i=1, . . . , n for which the relation zᵢ(\vec{x}ᵥ)< z̅ₙ₊₁(\vec{x}ᵥ) is fulfilled, otherwise decrementing from wᵢ(\vec{x}ᵥ) by 1, and decrementing from w̅ₙ₊₁(\vec{x}ᵥ) by 1, for each i=1, . . . , n for which the relation z̅ᵢ(\vec{x}ᵥ)< z̅ₙ₊₁(\vec{x}ᵥ) is fulfilled, otherwise decrementing from w̅ᵢ(\vec{x}ᵥ) by 1.

In accordance with another feature of the instant invention, the method further includes adding another location probability range Rₙ₊₁ to the already existing location probability ranges Rᵢ, i=1, . . . ,n, and for each grid point \vec{x}ᵥ, quantizing the lower limiting area zₙ₊₁ and upper limiting area z̅ₙ₊₁ of the (n+1)^{th} location probability range Rₙ₊₁ by assigning a lower limiting value zₙ₊₁(\vec{x}ᵥ) and an upper limiting value z̅ₙ₊₁(\vec{x}ᵥ) to the grid point \vec{x}ᵥ, assigning a number wₙ₊₁(\vec{x}ᵥ) or w̅ₙ₊₁(\vec{x}ᵥ) to each limiting value zₙ₊₁(\vec{x}ᵥ) or z̅ₙ₊₁(\vec{x}ᵥ), respectively provided with the initialization value wₙ₊₁(\vec{x}ᵥ)=1 or w̅ₙ₊₁(\vec{x}ᵥ)=1, decrementing from wᵢ(\vec{x}ᵥ) by 1, for each i=1, . . . , n for which the relation zᵢ(\vec{x}ᵥ)<zₙ₊₁(\vec{x}ᵥ) is fulfilled, otherwise decrementing from wₙ₊₁(\vec{x}ᵥ) by 1, decrementing from w̅ᵢ(\vec{x}ᵥ) by 1, for each i=1, . . . , n for which the relation z̅ᵢ(\vec{x}ᵥ)<xₙ₊₁(\vec{x}ᵥ) is fulfilled, otherwise incrementing from wₙ₊₁(\vec{x}ᵥ) by 1, incrementing from wᵢ(\vec{x}ᵥ) by 1, for each i=1, . . . , n for which the relation zᵢ(\vec{x}ᵥ)< z̅ₙ₊₁(\vec{x}ᵥ) is fulfilled, otherwise decrementing from w̅ₙ₊₁(\vec{x}ᵥ) by 1, and incrementing from w̅ᵢ(\vec{x}ᵥ) by 1, for each i=1, . . . , n for which the relation z̅ᵢ(\vec{x}ᵥ)< z̅ₙ₊₁(\vec{x}ᵥ) is fulfilled, otherwise incrementing from w̅ₙ₊₁(\vec{x}ᵥ) by 1.

According to another feature, the incrementing and decrementing may be performed in any sequence. Alternatively, the incrementing and decrementing can be performed in any sequence.

Further, the method can be performed completely or in part after the sensor measured values are ascertained. Also, the method may be performed completely or in part after the sensor measured values are ascertained.

Moreover, the method can be performed completely or in part while the sensor measured values are ascertained. Alternatively, the method may be performed completely or in part while the sensor measured values are ascertained.

The present invention is directed to a method for the database-driven estimate of an output quantity in a k-dimensional value range. The method includes establishing a two-dimensional plane, defining at least three overlapping probability ranges in a plane perpendicular to the two-dimensional plane, wherein each probability range comprises an upper limit and a lower limit, establishing a reference line within the plane perpendicular to the two-dimensional plane that intersects the three overlapping probability ranges at an intersection point, assigning a number to each intersection point corresponding to a number of probability ranges the intersection point is located in or on, and computing an interval between intersection points located in or on all probability ranges.

In accordance with still yet another feature of the present invention, the two-dimensional plane is a horizontal plane.

Other exemplary embodiments and advantages of the present invention may be ascertained by reviewing the present disclosure and the accompanying drawing.

### BRIEF DESCRIPTION OF THE DRAWING

The present invention is further described in the detailed description which follows, in reference to the noted drawing by way of non-limiting example of an exemplary embodiment of the present invention, wherein:

The FIGURE illustrates a three-dimensional system in accordance with the instant invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The single FIGURE explains the invention by way of example for the specific 3-dimensional case. The FIGURE shows a Cartesian coordinate system, in which a 2-dimensional discrete search grid has been laid over the x-y plane. The FIGURE further shows, by way of example, three location probability ranges R₁, R₂, and R₃. The shape of the location probability ranges R₁, R₂, and R₃ is chosen to be plane-parallel by way of example. Naturally, the location probability ranges R₁, R₂, and R₃ can assume any shape in the 3-dimensional space.

Let S be the range in which all the location probability ranges R₁, R₂, and R₃ overlap. The individual location probability ranges R₁, R₂, and R₃ are respectively limited by their upper areas z̅ᵢ(x, y) and lower areas zᵢ(x, y) with i=1, 2, 3.

By way of better illustration, the upper areas z̅ᵢ(x, y) and the lower areas zᵢ(x, y) are shown to be parallel. Naturally, the respective upper areas z̅ᵢ(x, y) and lower areas zᵢ(x, y) can respectively have an arbitrary shape and an arbitrary course with respect to one another.

A reference line HL runs parallel to the z-axis from the point (x, y) in the x-y plane. This reference line HL merely serves the purpose of better illustration and shows the vertical projection of the point (x, y) to the areas z̅ᵢ and zᵢ. The reference line HL intersects the areas z̅ᵢ und zᵢ of the individual probability ranges R₁, R₂, and R₃ in the points z̅ᵢ(x, y) and zᵢ(x, y). A number w̅ᵢ(x, y) is thereby assigned to each point z̅ᵢ(x, y), and a number w̅ᵢ(x, y) is assigned to each point zᵢ(x, y). Each number w̅ᵢ(x, y) thereby states in how many probability ranges Rᵢ the respective point z̅ᵢ(x, y) lies. And each number wᵢ(x, y) thereby states in how many probability ranges Rᵢ the respective point zᵢ(x, y) lies.

The FIGURE illustrates that, e.g., the point z̅₂(x, y) lies in all three probability ranges R₁ through R₃, as a result of which the number w̅₂(x, y) assigned to the point has a value 3. The point z₂(x, y), however, lies only in probability range R₂. The number w₂ (x, y) assigned to the point z₂ (x, y) thus has the value 1.

At the same time, the entire value range between the points z₃(x, y) and z̅₂(x, y), both with an associated value number 3, lies in the overlap range S of the three location probability ranges R₁ through R₃. This shows that the overlap range in the separated z-dimension, here the interval between the points z₃ (x, y) and z̅₂(x, y), is not determined by approximation, e.g., by quantizing the z-dimension, but is determined exactly by computation of the numbers zᵢ(x, y), wᵢ(x, y) and z̅ᵢ(x, y), w̅ᵢ(x, y).

In an advantageous embodiment of the invention the method is a recursive method, which allows the inclusion into the method of new space ranges Rₙ₊₁ starting from n=1, e.g., as a result of new measurements, without the method having to be restarted from the beginning.

In a first advantageous embodiment another location probability range Rₙ₊₁ is added to the already existing location probability ranges Rᵢ, i=1, . . . ,n according to the following recursive steps of the method, whereby the features of the method a1)-f1) are carried out for each grid point \vec{x}ᵥ:
a1. Quantizing the lower and upper limiting areas zₙ₊₁, z̅ₙ₊₁ of the (n+1)^{th} location probability range Rₙ₊₁ by assigning a lower limiting value zₙ₊₁(\vec{x}ᵥ) and an upper limiting value z̅ₙ₊₁(\vec{x}ᵥ) to the grid point \vec{x}ᵥ,
b1. Assigning a number wₙ₊₁(\vec{x}ᵥ) or w̅ₙ₊₁(\vec{x}ᵥ) to each limiting value zₙ₊₁(\vec{x}ᵥ) or Z̅ₙ₊₁(\vec{x}ᵥ) respectively provided with the initialization value whd n+1(\vec{x}ᵥ)=1 or
c1. For each i=1, . . . . , n for which the relation zᵢ(\vec{x}ᵥ)<zₙ₊₁(\vec{x}ᵥ) is fulfilled, incrementing from wₙ₊₁(\vec{x}ᵥ) by 1, otherwise incrementing from wᵢ(\vec{x}ᵥ) by 1,
d1. For each i=1, . . . , n for which the relation z̅ᵢ(\vec{x}ᵥ)<zₙ₊₁(\vec{x}ᵥ) is fulfilled, decrementing from wₙ₊₁(\vec{x}ᵥ) by 1, otherwise incrementing from w̅ᵢ(\vec{x}ᵥ) by 1,
e1. For each i=1, . . . , n for which the relation zᵢ(\vec{x}ᵥ)<zₙ₊₁(\vec{x}ᵥ) is fulfilled, incrementing from w̅ₙ₊₁(\vec{x}ᵥ) by 1, otherwise decrementing from wᵢ(\vec{x}ᵥ) by 1,
f1. For each i=1, . . . , n, for which the relation z̅ᵢ(\vec{x}ᵥ)< z̅ₙ₊₁(\vec{x}ᵥ) is fulfilled, decrementing from w̅ₙ₊₁(\vec{x}ᵥ) by 1, otherwise decrementing from w̅ᵢ(\vec{x}ᵥ) by 1.

In a second advantageous embodiment another location probability range Rₙ₊₁ is added to the already existing location probability ranges Rᵢ, i=1, . . . ,n according to the following recursive steps of the method, whereby the features of the method a1)-f1) are carried out for each grid point \vec{x}ᵥ:
a1. Quantizing the lower and upper limiting areas zₙ₊₁, z̅ₙ₊₁ of the (n+1)^{th} location probability range Rₙ₊₁ by assigning a lower limiting value zₙ₊₁(\vec{x}ᵥ) and an upper limiting value z̅ₙ₊₁(\vec{x}ᵥ) to the grid point \vec{x}ᵥ,
b1. Assigning a number wₙ₊₁(\vec{x}ᵥ) or w̅ₙ₊₁(\vec{x}ᵥ) to each limiting value zₙ₊₁(\vec{x}ᵥ) or z̅ₙ₊₁(\vec{x}ᵥ), respectively provided with the initialization value wₙ₊₁(\vec{x}ᵥ)=1 or w̅ₙ₊₁(\vec{x}ᵥ)=1,
c1. For each i=1, . . . , n for which the relation zᵢ(\vec{x}ᵥ)<zₙ₊₁(\vec{x}ᵥ) is fulfilled, decrementing from wᵢ(\vec{x}ᵥ) by 1, otherwise decrementing from wₙ₊₁(\vec{x}ᵥ) by 1,
d1. For each i=1, . . . . , n for which the relation z̅ᵢ(\vec{x}ᵥ)<zₙ₊₁(\vec{x}ᵥ) is fulfilled, decrementing from w̅ᵢ(\vec{x}ᵥ) by 1, otherwise incrementing from wₙ₊₁(\vec{x}ᵥ) by 1,
e1. For each i=1, . . . . , n for which the relation zᵢ(\vec{x}ᵥ)< z̅ₙ₊₁(\vec{x}ᵥ) is fulfilled, incrementing from wᵢ(\vec{x}ᵥ) by 1, otherwise decrementing from w̅ₙ₊₁(\vec{x}ᵥ) by 1,
f1. For each i=1, . . . . , n for which the relation z̅ᵢ(\vec{x}ᵥ)< z̅ₙ₊₁(\vec{x}ᵥ) is fulfilled, incrementing from w̅ᵢ(\vec{x}ᵥ) by 1, otherwise incrementing from w̅ₙ₊₁(\vec{x}ᵥ) by 1.

In the two alternatives, the above-noted features a1)-f1), starting from n=1, are run through as long as location probability ranges Rₙ₊₁ are added, e.g., in the course of a measurement series. Expediently, the sequence of features c1)-f1) is hereby arbitrary.

In an advantageous embodiment of the invention, the above-noted features of the method corresponding to paragraphs a), b), c), d), e) and the features of the method corresponding to paragraphs a1), b1), c1), d1), e1), f1) of the first or second alternative are carried out completely or in part after the end of the measurement series.

In a further advantageous embodiment of the invention, the features of the method corresponding to paragraphs a), b), c), d), e) and the features of the method corresponding to paragraphs a1), b1), c1), d1), e1), f1) of the first or second alternative are carried out completely or in part while the measurement series is carried out. The result (the probability range S of the output quantity to be estimated) can thus be provided at the end of the measurement series with minimum time delay.

An advantage of the recursive method is the fact that the number n of the location probability ranges does not have to be already determined at the beginning of the method or the measurement series, but can be adapted in the course of the measurement series.

The method according to the invention is particularly suitable for real-time applications, during which, e.g., in the course of a measurement series, new location probability ranges are gradually added. A situation of this type occurs, e.g., with TRN, where new location probability ranges in the form of space regions in which the aircraft is present are typically generated by the measurement every few seconds.

A further advantage lies in that the measurement series can be discontinued at any time. It is thus possible to dynamically adapt, e.g., the length of the measurement series to other parameters, even time-variable parameters, such as, e.g., the flight speed within the scope of TRN.

Finally, the method according to the invention is capable of exactly determining the overlap range at least in one dimension, e.g., the z-dimension, because there is no quantization in this direction.

The method according to the invention is not limited to the database-driven determination of the position of aircraft in the TRN method. The method can also be used in other fields of application, e.g., in the measurement of gray shade patterns in automatic image processing or in the geometric measurement of components in quality control.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A method for the database-driven estimate of an output quantity (\vec{x}, z) in a k-dimensional value range, method comprising:
determining a location probability range Rᵢ for a k-dimensional output quantity (\vec{x},z) for an element i of a measurement series {i=1, . . . ,n}, in which the location probability range Rᵢ is limited by a lower (k−1) dimensional area zᵢ and an upper (k−1) dimensional area z̅ᵢ, both of which are predetermined or parameterized with sensor measured values or derived from a database taking into account additional sensor measured values;
quantizing the lower limiting area zᵢ and the upper limiting area z̅ᵢ by assigning a lower limiting value zᵢ(\vec{x}ᵥ) and an upper limiting value z̅ᵢ(\vec{x}ᵥ) of the i^{th} location probability range Rᵢ to each point \vec{x}ᵥ in a predetermined (k−1) dimensional search grid, wherein the index i=1, . . . ,n refers to the respective location probability range Rᵢ and the index v refers to the points in the search grid;
assigning a number wᵢ(\vec{x}ᵥ) or w̅ᵢ(\vec{x}ᵥ) to each limiting value zᵢ(\vec{x}ᵥ) or z̅ᵢ(\vec{x}ᵥ), wherein the number wᵢ(\vec{x}ᵥ) corresponds to how many location probability ranges Rᵢ the point (\vec{x}ᵥ,zᵢ(\vec{x}ᵥ)) lies, and the number w̅ᵢ(\vec{x}ᵥ) respectively states in how many location probability ranges Rᵢ the point (\vec{x}ᵥ, z̅ᵢ(\vec{x}ᵥ)) lies, such that the special case n=1, w₁(\vec{x}ᵥ)=1 and w̅₁(\vec{x}ᵥ)=1 applies to all the grid points \vec{x}ᵥ; and
determining a probability range S for the output quantity to be estimated (\vec{x}, z), in which at least m of the n location probability ranges Rᵢ overlap, such that, when the number wᵢ(\vec{x}ᵥ) or w̅ᵢ(\vec{x}ᵥ) assigned to the limiting value zᵢ(\vec{x}ᵥ) or z̅ᵢ(\vec{x}ᵥ) is larger than or equal to m, each point (\vec{x}ᵥ,zᵢ(\vec{x}ᵥ)) or (\vec{x}ᵥ, z̅ᵢ(\vec{x}ᵥ)) lies within the probability range S, and, such that, when zᵢ(\vec{x}ᵥ)≦ Z̅ⱼ(\vec{x}ᵥ), wᵢ(\vec{x}ᵥ)≧m, w̅ⱼ(\vec{x}ᵥ)≧m applies and no limiting value zₗ(\vec{x}ᵥ) or z̅ᵢ(\vec{x}ᵥ) with wₗ(\vec{x}ᵥ)≦m or w̅ₗ(\vec{x}ᵥ)≦m exists between zᵢ(\vec{x}ᵥ), z̅ⱼ(\vec{x}ᵥ), the entire connecting distance of two points (\vec{x}ᵥ, zᵢ(\vec{x}ᵥ)), (\vec{x}ᵥ, z̅ⱼ(\vec{x}ᵥ)) lies within the probability range S.

2. The method in accordance with claim 1, further comprising adding another location probability range Rₙ₊₁ to the already existing location probability ranges Rᵢ, i=1, . . . ,n, and, for each grid point \vec{x}ᵥ:
quantizing lower limiting area zₙ₊₁ and upper limiting area z̅ₙ₊₁ of the (n+1)^{th} location probability range Rₙ₊₁ by assigning a lower limiting value zₙ₊₁(\vec{x}ᵥ) and an upper limiting value z̅ₙ₊₁(\vec{x}ᵥ) to the grid point \vec{x}ᵥ;
assigning a number wₙ₊₁(\vec{x}ᵥ) or w̅ₙ₊₁(\vec{x}ᵥ) to each limiting value zₙ₊₁(\vec{x}ᵥ) or z̅ₙ₊₁(\vec{x}ᵥ), respectively provided with the initialization value wₙ₊₁(\vec{x}ᵥ)=1 or w̅ₙ₊₁(\vec{x}ᵥ)=1;
incrementing from wₙ₊₁(\vec{x}ᵥ) by 1, for each i=1, . . . , n for which the relation zᵢ(\vec{x}ᵥ)<zₙ₊₁(\vec{x}ᵥ) is fulfilled, otherwise incrementing from wᵢ(\vec{x}ᵥ) by 1;
decrementing from wₙ₊₁(\vec{x}ᵥ) by 1, for each i=1, . . . , n for which the relation z̅ᵢ(\vec{X}ᵥ)<zₙ₊₁(\vec{x}ᵥ) is fulfilled, otherwise incrementing from w̅ᵢ(\vec{x}ᵥ) by 1;
incrementing from w̅ₙ₊₁(\vec{x}ᵥ) by 1, for each i=1, . . . , n for which the relation zᵢ(\vec{x}ᵥ)< z̅ₙ₊₁(\vec{x}ᵥ) is fulfilled, otherwise decrementing from wᵢ(\vec{x}ᵥ) by 1; and
decrementing from w̅ₙ₊₁(\vec{x}ᵥ) by 1, for each i=1, . . . , n for which the relation z̅ᵢ(\vec{x}ᵥ)< z̅ₙ₊₁(\vec{x}ᵥ) is fulfilled, otherwise decrementing from w̅ᵢ(\vec{x}ᵥ) by 1.

3. The method in accordance with claim 1, further comprising adding another location probability range Rₙ₊₁ to the already existing location probability ranges Rᵢ, i=1, . . . ,n, and for each grid point \vec{x}ᵥ:
quantizing the lower limiting area zₙ₊₁ and upper limiting area z̅ₙ₊₁ of the (n+1)^{th} location probability range Rₙ₊₁ by assigning a lower limiting value zₙ₊₁(\vec{x}ᵥ) and an upper limiting value z̅ₙ₊₁(\vec{x}ᵥ) to the grid point \vec{x}ᵥ;
assigning a number wₙ₊₁ (\vec{x}ᵥ) or w̅ₙ₊₁(\vec{x}ᵥ) to each limiting value zₙ₊₁(\vec{x}ᵥ) or z̅ₙ₊₁(\vec{x}ᵥ), respectively provided with the initialization value wₙ₊₁(\vec{x}ᵥ)=1 or w̅ₙ₊₁(\vec{x}ᵥ)=1;
decrementing from wᵢ(\vec{x}ᵥ) by 1, for each i=1, . . . , n for which the relation zᵢ(\vec{x}ᵥ)<zₙ₊₁(\vec{x}ᵥ) is fulfilled, otherwise decrementing from wₙ₊₁(\vec{x}ᵥ) by 1;
decrementing from w̅ᵢ(\vec{x}ᵥ) by 1, for each i=1, . . . , n for which the relation z̅ᵢ(\vec{x}ᵥ)<zₙ₊₁(\vec{x}ᵥ) is fulfilled, otherwise incrementing from wₙ₊₁(\vec{x}ᵥ) by 1;
incrementing from wᵢ(\vec{x}ᵥ) by 1, for each i=1, . . . , n for which the relation zᵢ(\vec{x}ᵥ)< z̅ₙ₊₁(\vec{x}ᵥ) is fulfilled, otherwise decrementing from wₙ₊₁(\vec{x}ᵥ) by 1; and
incrementing from w̅ᵢ(\vec{x}ᵥ) by 1, for each i=1, . . . , n for which the relation z̅ᵢ(\vec{x}ᵥ)< z̅ₙ₊₁(\vec{x}ᵥ) is fulfilled, otherwise incrementing from w̅ₙ₊₁(\vec{x}ᵥ) by 1.

4. The method in accordance with claim 2, wherein the incrementing and decrementing are performed in any sequence.

5. The method in accordance with claim 3, wherein the incrementing and decrementing are performed in any sequence.

6. The method in accordance with claim 2, wherein the method is performed completely or in part after the sensor measured values are ascertained.

7. The method in accordance with claim 3, wherein the method is performed completely or in part after the sensor measured values are ascertained.

8. The method in accordance with claim 2, wherein the method is performed completely or in part while the sensor measured values are ascertained.

9. The method in accordance with claim 3, wherein the method is performed completely or in part while the sensor measured values are ascertained.

10. A method for the database-driven estimate of an output quantity in a k-dimensional value range, method comprising:
establishing a two-dimensional plane;
defining at least three overlapping probability ranges in a plane perpendicular to the two-dimensional plane, wherein each probability range comprises an upper limit and a lower limit;
establishing a reference line within the plane perpendicular to the two-dimensional plane that intersects the three overlapping probability ranges at an intersection point;
assigning a number to each intersection point corresponding to a number of probability ranges the intersection point is located in or on; and
computing an interval between intersection points located in or on all probability ranges.

11. The method in accordance with claim 10, wherein the two-dimensional plane is a horizontal plane.
